(19) United States
(12) Patent Application Publication
(10) Pub. No.: US 2009/0320948 A1
(43) Pub. Date: Dec. 31, 2009

(54) STACKED LOAD LOCK CHAMBER AND SUBSTRATE PROCESSING APPARATUS INCLUDING THE SAME

(75) Inventors: Hirofumi Asanuma, Hachioji-shi (JP); Toshikazu Nakazawa, Saitama-shi (JP)

Correspondence Address: FITZPATRICK CELLA HARPER & SCINTO, 1290 Avenue of the Americas, NEW YORK, NY, 10104-3800, US

(73) Assignee: CANON ANELVA CORPORATION, Kawasaki-shi (JP)

(21) Appl. No.: 12/482,050

(22) Filed: Jun. 10, 2009

(30) Foreign Application Priority Data
Jun. 30, 2008 (JP) 2008-170393
Apr. 9, 2009 (JP) 2009-095145

(51) Int. Cl. F16K 11/02

(52) U.S. Cl. 137/627.5

(57) ABSTRACT

A stacked load lock chamber comprises a first load lock chamber, a second load lock chamber stacked on the first load lock chamber, a first slit-valve mover configured to open and close a first opening provided to an atmosphere side of the first load lock chamber, a second slit-valve mover configured to open and close a second opening provided to an atmosphere side of the second load lock chamber, a first arm connected to the first slit-valve mover, a second arm connected to the second slit-valve mover, and a driver located below the first and second load lock chambers and configured to drive the first and second arms to move the first and second slit-valve movers through the first and second arms.

### BACKGROUND OF THE INVENTION

1. Field of the Invention

The present invention relates to a stacked load lock chamber and a substrate processing apparatus including the same.

2. Description of the Related Art

Japanese Patent Laid-Open Nos. 11-330199 and 2001-44258 disclose processing apparatuses each including a load lock chamber in which two chambers are stacked in the vertical direction.

FIG. 1 of Japanese Patent Laid-Open No. 11-330199 discloses a vacuum processing apparatus in which a process chamber, transfer chamber, and load lock chamber are arranged in line in this order. This load lock chamber is a two-stage chamber in which a heating chamber and cooling chamber are stacked vertically. FIG. 3 of Japanese Patent Laid-Open No. 11-330199 discloses an arrangement in which a gate valve for the heating chamber and a gate valve for the cooling chamber are arranged separately.

Japanese Patent Laid-Open No. 2001-44258 discloses a substrate processing apparatus in which a plurality of load lock chambers each having vertical multistages are arranged around a transfer chamber, so that a plurality of target substrates can be accommodated simultaneously. Also, according to FIGS. 2 to 4 of Japanese Patent Laid-Open No. 11-330199, each load lock chamber of the vertical stages includes an opening/closing door 204.

The load lock chamber is a chamber which isolates the atmosphere side from the vacuum side. When loading a substrate into the load lock chamber from the atmosphere side and unloading a substrate from the load lock chamber to the atmosphere side, particles may flow from the atmosphere side into the load lock chamber. If the particles flowing into the load lock chamber are attached to the substrate, a defect resulting from the particles may occur in the substrate after the process.

In an arrangement in which a load lock chamber is provided with a gate valve and opening/closing door, if a driving mechanism that opens/closes the gate valve or opening/closing door is located at a position equal to or higher than that of the opening of the load lock chamber, inconveniences occur. More specifically, when the driving mechanism is operated, the sliding portion of the driving mechanism may produce particles. While such particles drop down, they may flow into the load lock chamber through its opening.

### SUMMARY OF THE INVENTION

The present invention provides a technique advantageous for reducing the risk of particles flowing into the load lock chamber from the atmosphere side.

According to the first aspect of the present invention, there is provided a stacked load lock chamber comprising a first load lock chamber, a second load lock chamber stacked on the first load lock chamber, a first slit-valve mover configured to open and close a first opening provided to an atmosphere side of the first load lock chamber, a second slit-valve mover configured to open and close a second opening provided to an atmosphere side of the second load lock chamber, a first arm connected to the first slit-valve mover, a second arm connected to the second slit-valve mover, and a driver located below the first and second load lock chambers and configured to drive the first and second arms to move the first and second slit-valve movers through the first and second arms.

According to the second aspect of the present invention, there is provided a substrate processing apparatus comprising a cylindrical transfer chamber including a polygonal bottom surface and a polygonal upper surface, and a plurality of side surfaces connected to a plurality of process chambers, and the above stacked load lock chamber which is connected to adjacent ones of the plurality of side surfaces of the transfer chamber.

Further features of the present invention will become apparent from the following description of exemplary embodiments with reference to the attached drawings.

### BRIEF DESCRIPTION OF THE DRAWINGS

FIG. 1 is a schematic perspective plan view showing the arrangement of a substrate processing apparatus according to an embodiment;

FIG. 2A is a sectional side view, seen from the direction of an arrow X in FIG. 1, of a load lock chamber taken along the line A-B in FIG. 1;

FIG. 2B is a sectional side view, seen from the direction of the arrow X in FIG. 1, of the load lock chamber taken along the line A-B in FIG. 1;

FIG. 2C is a sectional side view, seen from the direction of the arrow X in FIG. 1, of the load lock chamber taken along the line A-B in FIG. 1;

FIG. 3A is a schematic sectional view of the load lock chamber seen from the direction of an arrow Y in FIG. 1;

FIG. 3B is a schematic sectional view of the load lock chamber seen from the direction of the arrow Y in FIG. 1;

FIG. 4 is a schematic sectional view of the load lock chamber seen from the direction of the arrow Y in FIG. 1; and

FIGS. 5A and 5B are schematic sectional views of a vacuum processing apparatus.

### DESCRIPTION OF THE EMBODIMENTS

Embodiments of the present invention will be described hereinafter with reference to the accompanying drawings.

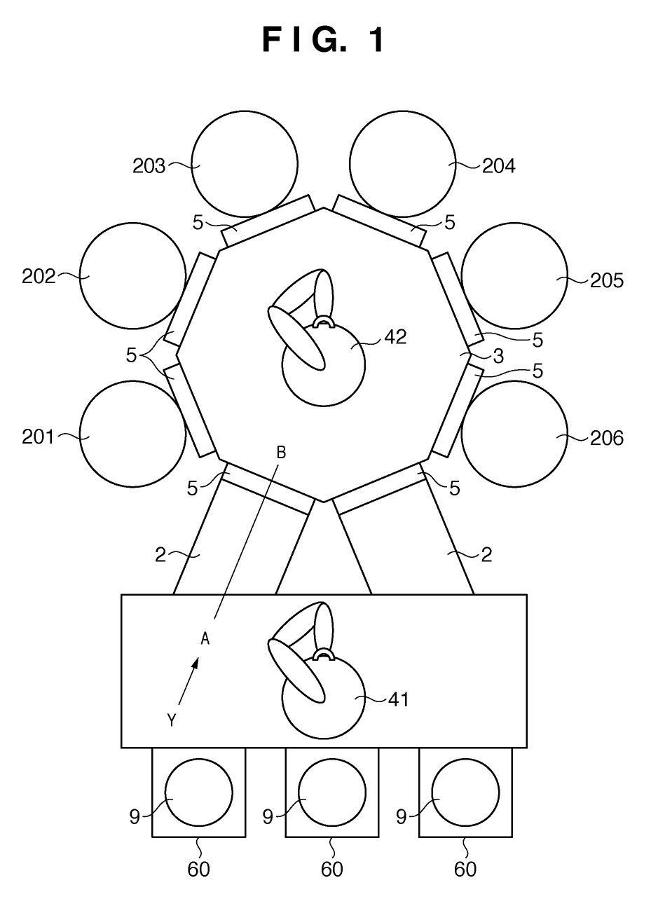

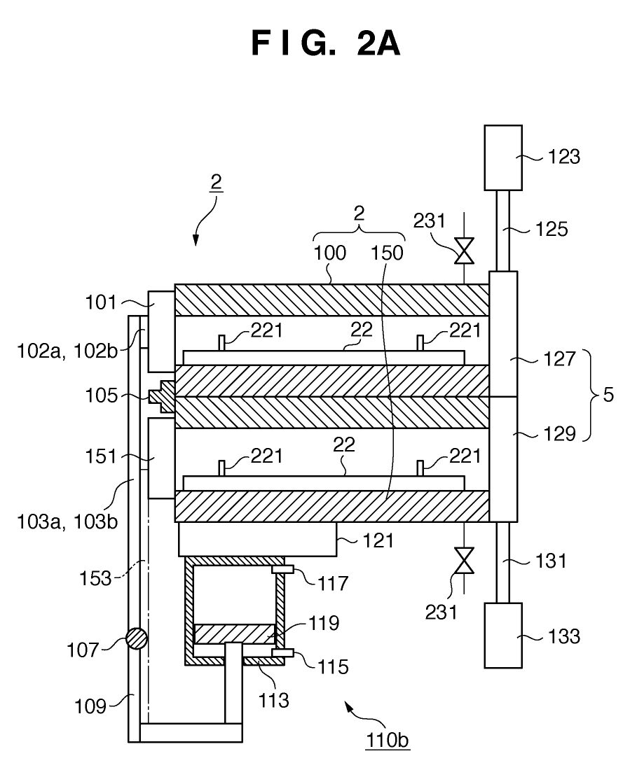

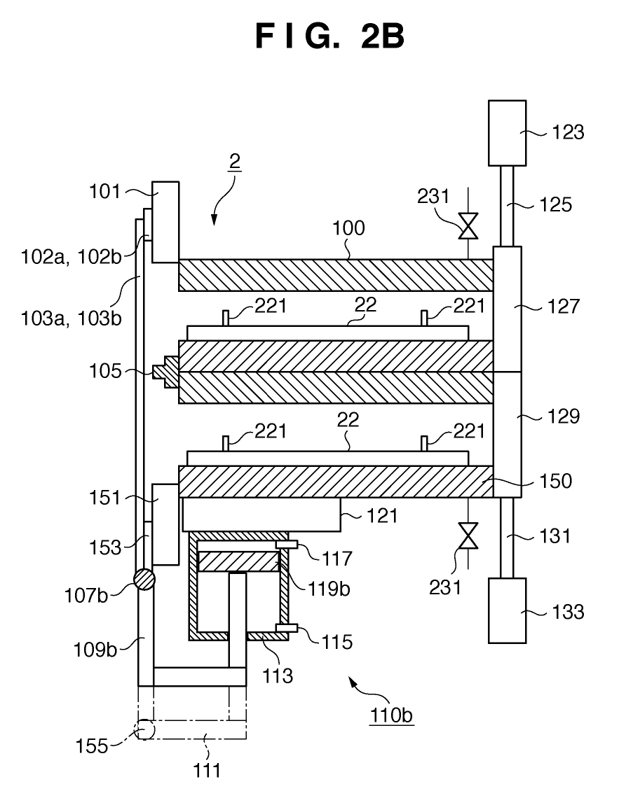

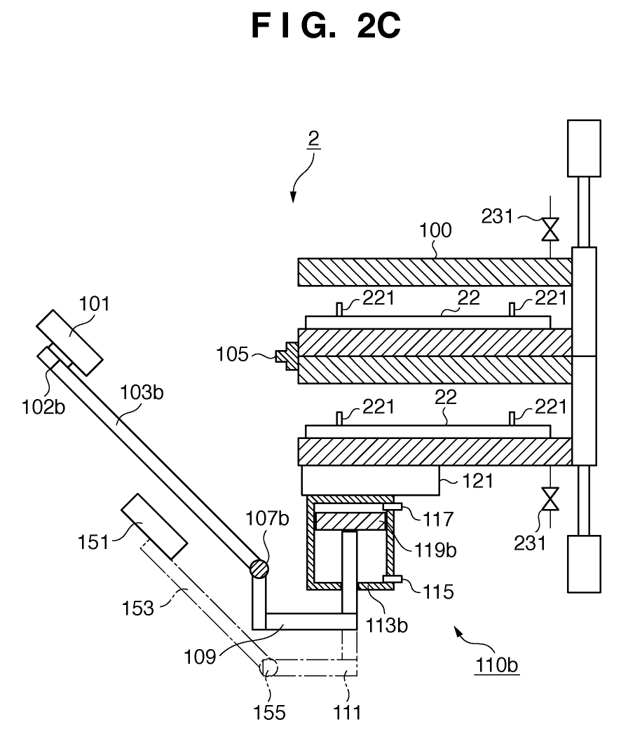

First, the arrangement of a cluster type substrate processing apparatus according to an embodiment will be described with reference to FIGS. 1 and 2. FIG. 1 is a schematic perspective plan view showing the arrangement of the substrate processing apparatus according to the embodiment.

As shown in FIG. 1, the substrate processing apparatus according to the embodiment includes a transfer chamber 3 which is arranged at the center and can be evacuated, and a plurality of process chambers 201 to 206 and a plurality of stacked load lock chambers 2 arranged around the transfer chamber 3. According to this embodiment, the transfer chamber 3 forms an almost octagonal cylinder. The eight side surfaces of the transfer chamber 3 are connected to the process chambers 201, 202, 203, 204, 205, and 206 and stacked load lock chambers 2. The transfer chamber 3 is connected to the process chambers 201 to 206 and stacked load lock chambers 2 through gate valves 5 so that the transfer chamber 3 can be maintained airtight. The process chambers 201 to 206 can be formed as the chambers of a processing apparatus selected from, e.g., a sputtering deposition apparatus, chemical vapor deposition (CVD) apparatus, and dry etching apparatus. Each stacked load lock chamber 2 includes a plurality of load lock chambers 100 and 150 that are stacked vertically. In this specification “stacked” means that two members are vertically arranged to overlap. The two members need not overlap completely but it suffices if they overlap at least by half when seen from the top.

According to this embodiment, the transfer chamber 3 forms an almost octagonal cylinder. However, the arrangement of the transfer chamber 3 is not limited to this. For example, the transfer chamber 3 may have a cylindrical shape with a bottom surface and upper surface which are arbitrary polygons. The plurality of process chambers are connected to the plurality of side surfaces of such polygonal cylindrical transfer chamber 3.

Furthermore, as shown in FIG. 1, the substrate processing apparatus of this embodiment can include an autoloader 41. For example, the autoloader 41 is constituted by an articulated robot including an arm that can be moved within a horizontal plane and vertically. The autoloader 41 transports substrates 9 between, e.g., three external cassettes 60 and the load lock chambers 100 and 150.

The transfer chamber 3 incorporates a transport mechanism 42 which transports the substrates 9 between the chambers 201 to 206 and the chamber 2. For example, the transport mechanism 42 is constituted by an articulated robot including an arm on which the substrate 9 is to be placed, and can transport the substrate 9 to an arbitrary position in a horizontal plane and an arbitrary position in the vertical direction within the work range.

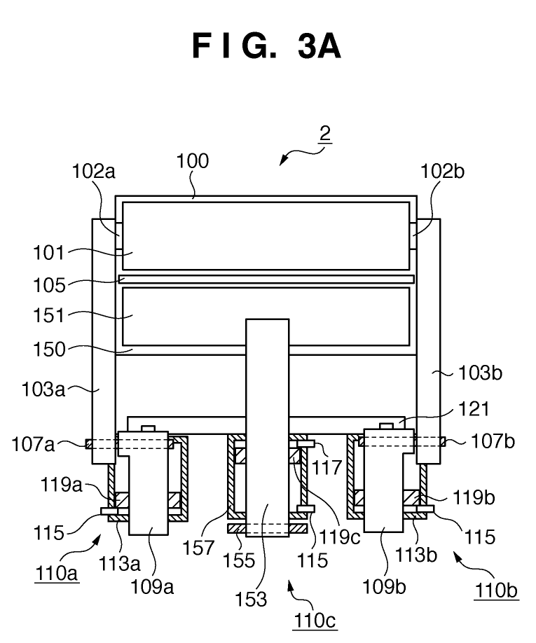

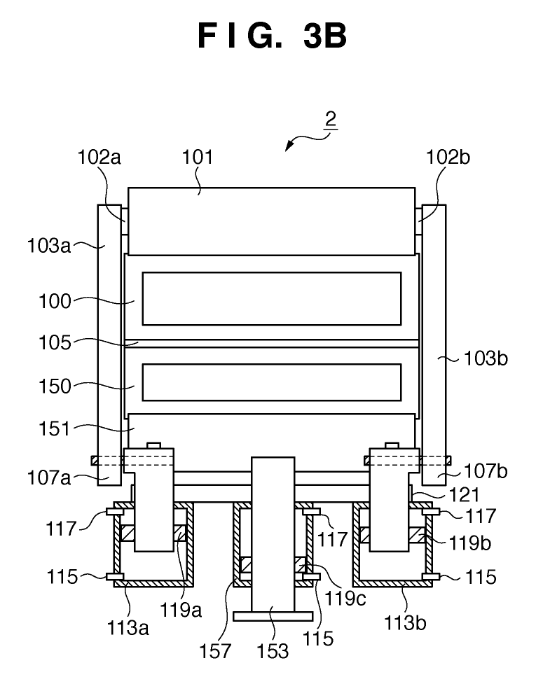

An arrangement of the load lock chamber 2 according to this embodiment will be described in detail hereinafter with reference to FIGS. 2A to 3B.

FIGS. 2A to 2C are schematic sectional views, respectively, of the stacked load lock chamber 2 taken along the line A-B in FIG. 1. In FIGS. 2A to 2C, the vacuum side transfer chamber 3 is arranged on the right side, and the atmosphere-side autoloader 41 is arranged on the left side. The stacked load lock chamber 2 includes the plurality of load lock chambers 100 and 150 which are stacked vertically. FIG. 2A shows a state in which upper and lower slit-valve movers 101 and 151 close the atmosphere-side openings of the upper and lower load lock chambers 100 and 150, respectively. FIG. 2B shows a state in which the upper and lower slit-valve movers 101 and 151 of the atmosphere-side openings of the upper and lower load lock chambers 100 and 150, respectively, are open. FIG. 2C shows a state in which the slit valves 101 and 151 are separated from the atmosphere-side openings of the upper and lower load lock chambers 100 and 151, respectively, and the slit-valve movers 101 and 151 are retreated to positions where they will not hinder the maintenance or cleaning of the load lock chambers 100 and 150. Note that the valve mover can be called a valve element or valve door as well.

FIGS. 3A and 3B are schematic views of the load lock chamber seen from the direction of an arrow Y in FIG. 1. FIG. 3A shows a state in which the upper and lower slit-valve movers 101 and 151 close the atmosphere-side openings of the upper and lower load lock chambers 100 and 150, respectively. FIG. 3B shows a state in which the upper and lower slit-valve movers 101 and 151 of the atmosphere-side openings of the upper and lower load lock chambers 100 and 151 are open.

The stacked load lock chamber 2 of this embodiment has a structure in which the upper load lock chamber 100 as the second load lock chamber is stacked on the lower load lock chamber 150 as the first load lock chamber so they are adjacent. The substrates 9 can be loaded in and unloaded from the upper and lower load lock chambers 100 and 150 through the atmosphere-side (autoloader 41) opening and the vacuum-side (transfer chamber 3) opening.

Each of the upper and lower load lock chambers 100 and 150 of this embodiment accommodates one substrate 9 and has a very small rectangular parallelepiped internal space with a size of, e.g., 330 mm (width)×330 mm (depth)×15 mm (height). The size of each of the upper and lower load lock chambers 100 and 150 is determined to be able to accommodate a 300-mm diameter semiconductor wafer as the substrate 9. Each of the load lock chambers 100 and 150 of this embodiment is larger than the substrate 9 by only 20 mm in width and depth. Each of the load lock chambers 100 and 150 of this embodiment has a dedicated exhaust system 231 including a pump. Each of the load lock chambers 100 and 150 has, in the internal space, a substrate holder 22 having substrate holding pins 221.

Each of the load lock chambers 100 and 150 has a small internal space in this manner, and the time (to be referred to as the “exhaust time” hereinafter) required to evacuate it by the corresponding exhaust system 231 is short accordingly. As the exhaust systems 231 of the load lock chambers 100 and 150, for example, dry pumps each with an exhaust rate of about 1,000 l/min can be used. In a certain prior art, the evacuation time required to evacuate a load lock chamber to about 1×10⁻¹ Torr to 5×10⁻² Torr (13.3 Pa to 6.67 Pa) by a similar dry pump is about 180 sec to 240 sec. With this embodiment, the load lock chamber can be evacuated in about 15 sec to 20 sec, which is about 1/10 to 1/16 the time of the prior art.

The arrangement concerning the upper load lock chamber 100 and upper slit-valve mover 101 and the opening operation of the upper slit-valve mover 101 will now be described.

As shown in FIGS. 2A and 3A, the upper load lock chamber 100 is provided with the upper slit-valve mover 101 serving as the second slit-valve mover which can open/close the atmosphere-side opening, so that the upper load lock chamber 100 can be isolated from and communicate with the atmosphere. That portion of the upper slit-valve mover 101 which abuts against the edge end face of the atmosphere-side opening of the upper load lock chamber 100 is provided with a sealing member such as an O-ring. Thus, when the upper slit-valve mover 101 closes the atmosphere-side opening of the upper load lock chamber 100, the upper load lock chamber 100 forms a highly hermetic sealed space.

The upper slit-valve mover 101 is connected to an upper left arm 103a and upper right arm 103b as the second arm through connecting members 102a and 102b, respectively. The upper left arm 103a is connected to an arm driver 110a arranged below the load lock chamber 2 via the left side of the atmosphere-side opening of the load lock chamber 2. The upper right arm 103b is connected to an arm driver 110b arranged below the load lock chamber 2 via the right side of the atmosphere-side opening of the load lock chamber 2. The arm drivers 110a and 110b drive the upper left arm 103a and upper right arm 103b, respectively, to move the upper slit-valve mover 101 between an opening position for opening the atmosphere-side opening of the upper load lock chamber 100 and a closing position for closing this opening.

In this embodiment, the arm driver 110a is formed of an air cylinder. The air cylinder includes a cylinder 113a and a piston 119a which can reciprocate in the cylinder 113a. The cylinder 113a is provided with two air ports 115 and 117 to move the piston 119a. The air port 115 communicates with the first space in the cylinder 113a, and the air port 117 communicates with the second space in the cylinder 113a. The piston 119a separates the first and second spaces from each other. The upper left arm 103a is connected to a U-shaped connecting member 109a through an upper left hinge 107a serving as the second hinge, and one end of the U-shaped connecting member 109a is fixed to the distal end of the piston 119a. The upper left hinge 107a includes a shaft member extending through a hole formed in the upper left arm 103a and a hole formed in the U-shaped connecting member 109a. The upper left arm 103a can rotate about this shaft member.

In this embodiment, the arm driver 110b is formed of an air cylinder. The air cylinder includes a cylinder 113b and a piston 119b which can reciprocate in the cylinder 113b. The cylinder 113b is provided with two air ports 115 and 117 to move the piston 119b. The upper right arm 103b is connected to a U-shaped connecting member 109b through an upper right hinge 107b serving as the second hinge, and one end of the U-shaped connecting member 109b is fixed to the distal end of the piston 119b. The upper right hinge 107b includes a shaft member extending through a hole formed in the upper right arm 103b and a hole formed in the U-shaped connecting member 109b. The upper right arm 103b can rotate about this shaft member. The arm drivers 110a and 110b are fixed to the lower surface of a base plate 121 arranged below the load lock chamber 2.

The opening operation of the upper slit-valve mover 101 will be described with reference to FIGS. 2A and 2B.

Air is supplied into the cylinders 113a and 113b through the air ports 115 and discharged outside from the upper cylinders 113a and 113b through the air port 117. This moves the pistons 119a and 119b in the cylinders 113a and 113b to the upper positions (see FIG. 2B) in the cylinders 113a and 113b, respectively. As described above, the pistons 119a and 119b are connected to the upper slit-valve mover 101 through the connecting members 109a and 109b, upper arms 103a and 103b, and connecting members 102a and 102b, respectively. Therefore, as the pistons 119a and 119b move to the upper positions, the upper slit-valve mover 101 also moves to the upper position shown in FIG. 2B and opens the atmosphere-side opening of the upper load lock chamber 100. In this manner, the opening operation of the upper slit-valve mover 101 is achieved. The closing operation of the upper slit-valve mover 101 is performed by supplying air into the upper cylinders 113a and 113b through the air port 117 and discharging air outside from the upper cylinders 113a and 113b through the air ports 115.

As shown in FIG. 2A, an upper slit-valve mover 127 is arranged between the vacuum-side opening of the upper load lock chamber 100 and the transfer chamber 3. The upper slit-valve mover 127 is connected to an upper driver 123 arranged above the load lock chamber 2 through a connecting member 125. The upper driver 123 vertically moves the upper gate slit-mover 127 through the connecting member 125. Thus, the upper slit-valve mover 127 can open/close the vacuum-side opening of the upper load lock chamber 100.

The arrangement concerning the lower load lock chamber 150 and lower slit-valve mover 151 and the opening operation of the lower slit-valve mover 151 will now be described.

As shown in FIGS. 2A and 3A, the lower load lock chamber 150 is provided with the lower slit-valve mover 151 serving as the first slit-valve which can open/close the atmosphere-side opening, so that the lower load lock chamber 150 can be isolated from and communicate with the atmosphere. That portion of the lower slit-valve mover 151 which abuts against the edge end face of the atmosphere-side opening of the lower load lock chamber 150 is provided with a sealing member such as an O-ring. Thus, when the lower slit-valve mover 151 closes the atmosphere-side opening of the lower load lock chamber 150, the lower load lock chamber 150 forms a highly hermetic sealed space.

The lower slit-valve mover 151 is connected to an arm driver 110c arranged below the load lock chamber 2 through a lower arm 153 serving as the first arm. The lower arm 153 extends vertically through the center of the load lock chamber 2 and is connected to the arm driver 110c. The arm driver 110c drives the lower arm 153 to move the lower slit-valve mover 151 between an opening position for opening the atmosphere-side opening of the lower load lock chamber 150 and a closing position for closing this opening.

In this embodiment, the arm driver 110c is formed of an air cylinder. The air cylinder includes a cylinder 157 and a piston 119c which can reciprocate in the cylinder 157. The cylinder 157 is provided with two air ports 115 and 117 to move the piston 119c. The air port 115 communicates with the first space in the cylinder 157, and the air port 117 communicates with the second space in the cylinder 157. The piston 119c separates the first and second spaces from each other. The lower arm 153 is connected to an L-shaped connecting member 111 through a lower hinge 155 serving as the first hinge, and one end of the L-shaped connecting member 111 is fixed to the distal end of the piston 119c. The lower hinge 155 includes a shaft member extending through a hole formed in the lower arm 153 and a hole formed in the L-shaped connecting member 111. The lower arm 153 can rotate about this shaft member.

In the same manner as the arm drivers 110a and 110b, the arm driver 110c is fixed to the lower surface of a base plate 121 arranged below the load lock chamber 2. Hence, all the arm drivers 110a, 110b, and 110c are fixed to one base plate 121.

The opening operation of the lower slit-valve mover 151 will be described with reference to FIGS. 3A and 3B.

Air is supplied into the lower cylinder 157 through the air port 117 and discharged outside from the lower cylinder 157 through the air port 115. This moves the piston 119c in the lower cylinder 157 to the lower position (see FIG. 3B) in the lower cylinder 157. As described above, the piston 119c is connected to the lower slit-valve mover 151 through the connecting member 111 and lower arm 153. Therefore, as the piston 119c moves to the lower position, the lower slit-valve mover 151 also moves to the lower position shown in FIG. 3B and opens the atmosphere-side opening of the lower load lock chamber 150. In this manner, the opening operation of the lower slit-valve mover 151 is realized. The closing operation of the lower slit-valve mover 151 is performed by supplying air into the lower cylinder 157 through the air port 117 and discharging air outside from the lower cylinder 158 through the air port 115.

As is understood from the above description, the lower slit-valve mover 151 moves downward when opening the atmosphere-side opening of the lower load lock chamber 150, and upward when closing this opening. In contrast to this, the upper slit-valve mover 101 moves upward when opening the atmosphere-side opening of the upper load lock chamber 100, and downward when closing this opening. In this manner, the lower slit-valve mover 151 and upper slit-valve mover 101 move in opposite directions when opening/closing.

As shown in FIG. 2A, a lower slit-valve mover 129 is arranged between the vacuum-side opening of the lower load lock chamber 150 and the transfer chamber 3. The lower slit-valve mover 129 is connected to a lower driver 133 arranged above the load lock chamber 2 through a connecting member 131. The lower driver 133 vertically moves the lower slit-valve mover 129 through the connecting member 131. Thus, the lower slit-valve mover 129 can open/close the vacuum-side opening of the lower load lock chamber 150.

As shown in FIG. 2A, a partition 105 is arranged between the upper slit-valve mover 101 and lower slit-valve mover 151. The partition 105 serves to receive particles that can be produced around the upper slit-valve mover 101 and fall upon opening/closing of the upper slit-valve mover 101. This prevents the particles produced upon opening/closing of the upper slit-valve mover 101 from falling around the atmosphere-side opening of the lower load lock chamber 150 and flowing into the lower load lock chamber 150.

The operation of the slit-valve mover during cleaning will be described with reference to FIG. 2C.

As shown in FIGS. 2B and 3B, when the slit-valve movers 101 and 151 are open, the arms 103a and 103b, and 153 connected to them can be rotated about the hinges 107b and 155 as the axes and tilted to the atmosphere side. Then, as shown in FIG. 2C, the slit-valve movers 101 and 151 and arms 103a and 103b, and 153 move to positions away from the atmosphere-side openings of the load lock chambers 100 and 150. Consequently, a work space necessary for removing the particles attached to the lower surfaces (surfaces opposing the load lock chambers) of the slit-valve movers 101 and 151 can be reserved, so that the slit-valves 101 and 151 can be cleaned well. As the arms 103a, 103b, and 153 can be tilted individually, the slit-valves 101 and 151 can be cleaned individually where needed.

The operation of the cluster type substrate processing apparatus will be described hereinafter by referring mainly to FIG. 1.

First, the autoloader 41 operates to transport the unprocessed substrates 9 from the external cassettes 60 to the upper load lock chambers 100 of the respective load lock chambers 2. The substrates 9 are placed on the substrate holding pins 221 (see FIG. 2A and the like) of the substrate holders 22 and positioned in the respective load lock chambers 100 and 150.

The transport mechanism 42 in the transfer chamber 3 extracts the substrates 9 with a predetermined order from the upper load lock chambers 100 of the respective stacked load lock chambers 2 and sends them to the process chambers 201, 202, 203, 204, 205, and 206. For example, the transport mechanism 42 extracts one substrate 9 from the upper load lock chamber 100 of the left stacked load lock chamber 2 in FIG. 1, and then another substrate 9 from the upper load lock chamber 100 of the right load lock chamber 2. The first substrate 9 is sent to the first process chamber 201 and heated to a predetermined temperature. Then, the second substrate 9 is sent to the second process chamber 202 and heated to the predetermined temperature in the same manner.

As a result, the substrates 9 that have been transported to the respective upper load lock chambers 100 of the two stacked load lock chambers 2 have undergone the process. Then, the autoloader 41 operates again and transports unprocessed substrates 9 from the external cassettes 60 to the respective upper load lock chambers 100 that are empty, so the upper load lock chambers 100 accommodate the substrates 9, respectively.

After that, the first substrate 9 in the first process chamber 201 is sent to the third process chamber 203 by the transport mechanism 42 and undergoes pre-process etching. During this period of time, the second substrate 9 stands by in the second process chamber 202. The transport mechanism 42 sends the third substrate 9 from the load lock chamber 2 to the first process chamber 201 which is empty.

Subsequently, when the first substrate 9 is sent to the fourth process chamber 204 and an underlying film is formed on it, the second substrate 9 which has been standing by in the second process chamber 202 is sent to the third process chamber 203, and the fourth substrate 9 is sent to the second process chamber 202 from the upper load lock chamber 100 of the stacked load lock chamber 2.

The first substrate 9 is sent from the fourth process chamber 204 to the fifth process chamber 205 and undergoes high-temperature reflow sputtering. After that, the first substrate 9 is sent to the sixth process chamber 206 and cooled, and an underlying film is formed on it. The second substrate 9 is transported to the process chamber immediately after the first substrate 9 is unloaded from it, and undergoes the same process as that performed for the first substrate 9 in this process chamber. In this manner, the second substrate 9 undergoes the same process as that for the first substrate 9 by following the same process procedure as that for the first substrate 9. This applies to the third and subsequent substrates 9 as well.

After that, the transport mechanism 42 returns the first substrate 9 from the sixth process chamber 206 to the lower load lock chamber 150 of the left stacked load lock chamber 2 in FIG. 1. The autoloader 41 returns the first substrate 9 from the lower load lock chamber 150 to the original position in the atmosphere-side external cassette 60. Then, the autoloader 41 operates promptly to transport the next substrate 9 to the upper load lock chamber 100.

In this manner, in the cluster type substrate processing apparatus shown in FIG. 1, the substrates 9 are sent to the respective process chambers 201 to 206 one by one via either one of the upper load lock chambers 100 of the left and right stacked load lock chambers and undergo processes. The processed substrates 9 are returned to the external cassettes 60 via the lower load lock chambers 150 of the left and right stacked load lock chambers. By repeating this process, all the substrates 9 set in the three external cassettes 60 are processed sequentially, and the processed substrates 9 are returned to the original positions in the external cassettes 60.

According to this embodiment, each of the upper and lower load lock chambers 100 and 150 of each stacked load lock chamber 2 has an internal space enough to accommodate one substrate 9, so that each stacked load lock chamber 2 is sufficiently compact. This shortens the entire time required for evacuating the stacked load lock chamber 2, thus improving the productivity of the apparatus.

Furthermore, according to this embodiment, the upper slit-valve mover 101 and lower slit-valve mover 151 are moved in opposite directions for opening/closing. Thus, the upper and lower load lock chambers 100 and 150 can be stacked close to each other. As a result, the load lock chamber 2 can be made compact.

Assume that the upper slit-valve mover 101 and lower slit-valve mover 151 are moved in the same direction for opening/closing. If the upper and lower load lock chambers 100 and 150 are stacked close to each other, inconveniences occur. More specifically, when both the upper and lower slit-valve movers 101 and 151 move upward, the lower slit-valve mover 151 undesirably covers the opening of the upper load lock chamber 100 partly. When both the upper and lower slit-valve movers 101 and 151 move downward, the upper slit-valve mover 101 undesirably covers the opening of the lower load lock chamber 150 partly. Hence, if the upper slit-valve mover 101 and lower slit-valve mover 151 are moved in the same direction for opening/closing, the upper and lower load lock chambers 100 and 150 must be spaced apart from each other. In this case, the stacked load lock chamber 2 inevitably becomes large by the space reserved between the upper and lower load lock chambers 100 and 150. In contrast to this, according to this embodiment, such space is not necessary, and accordingly the load lock chamber 2 can be made compact.

According to this embodiment, the arm drivers 110a to 110c are arranged below the corresponding stacked load lock chambers 2. Particles produced upon operation of the arm drivers 110a to 110c thus do not fall onto the load lock chambers 2. As a result, such particles flow into the stacked load lock chambers 2 and are attached to the substrates at a low possibility.

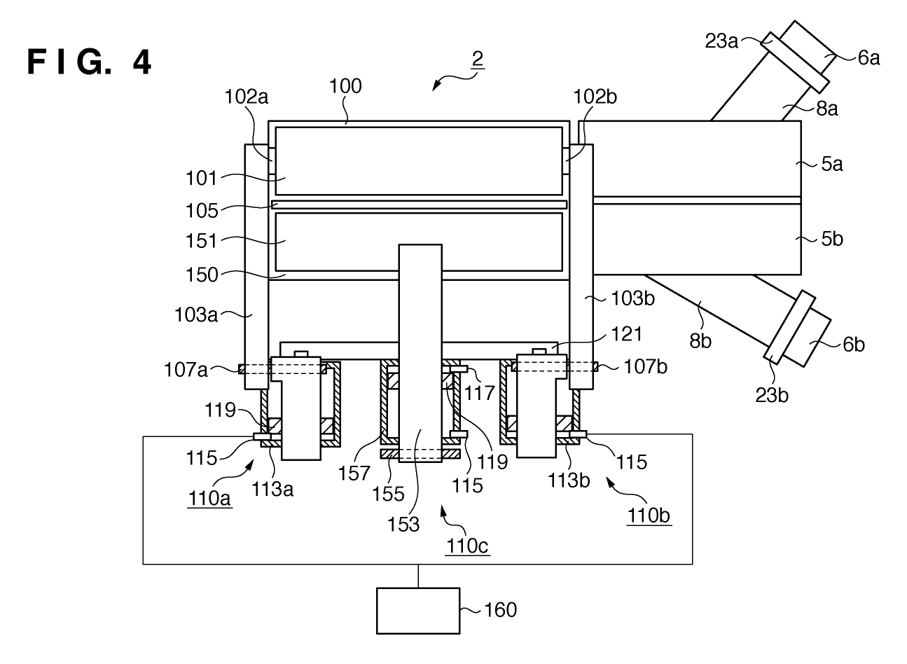

FIG. 4 shows a load lock chamber basically having the same arrangement as that in FIG. 3, which additionally includes an air source 160 to supply air to the arm drivers 110a and 110b. Air supplied from a single air source flows through the pipe and is evenly supplied to the arm drivers 110a and 110b. Thus, the upper left arm 103a and upper right arm 103b can be moved in a synchronous manner.

In the stacked load lock chamber 2 shown in FIG. 4, vacuum chambers (exhaust chambers) 5a and 5b to evacuate the stacked load lock chamber 2 are connected to the side of the load lock chamber 2. More specifically, the vacuum chamber 5a is connected to the side of the upper load lock chamber 100 of the stacked load lock chamber 2 through an opening. The vacuum chamber 5b is connected to the side of the lower load lock chamber 150 of the stacked load lock chamber 2 through an opening.

Although not shown, the upper load lock chamber 100 may be provided with an auxiliary exhaust port, and the exhaust port may be connected to an auxiliary pump through a connecting member. Similarly, the lower load lock chamber 150 may be provided with another auxiliary exhaust port, and the exhaust port may be connected to an auxiliary pump through a connecting member.

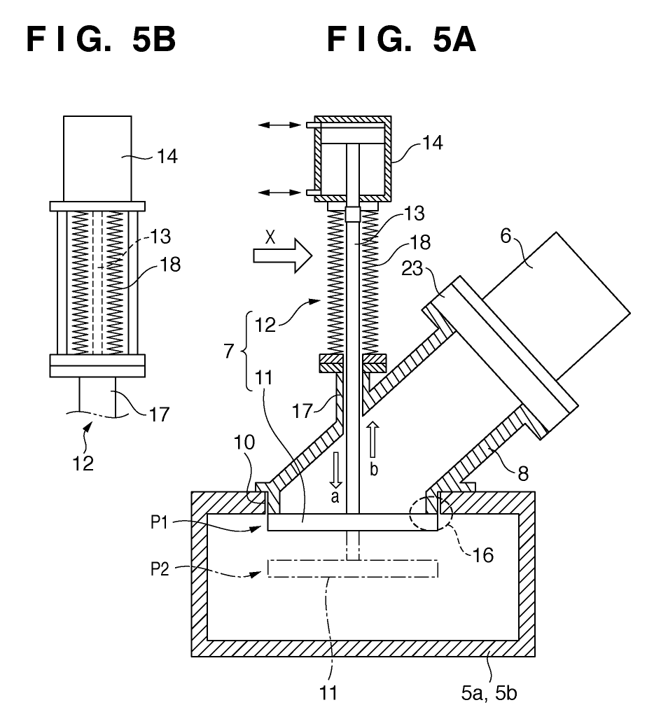

FIGS. 5A and 5B are views for describing in detail the vacuum chamber 5a or 5b described above. FIG. 5A is a sectional view of a vacuum processing apparatus, and FIG. 5B is a partial side view of the vacuum processing apparatus which is seen from the direction of an arrow X in FIG. 5A.

As shown in FIG. 5A, a vacuum processing apparatus 1 includes the vacuum chamber 5a or 5b, an exhaust pump 6 communicating with an exhaust port 10 of the vacuum chamber 5a or 5b, and a gate valve 7 having a valve element 11 which opens/closes the exhaust port 10.

The vacuum chamber 5a or 5b is provided with a connecting member 8. The connecting member 8 is connected to the exhaust port 10 as its one end is inserted in the exhaust port 10, and extends from the exhaust port 10 in a direction inclined with respect to the moving direction of the valve element 11. The other end of the connecting member 8 is connected to the exhaust pump 6.

The gate valve 7 includes the valve element 11 arranged in the vacuum chamber 5a or 5b and a driver 12 to drive the valve element 11. The driver 12 has a rod 13 and cylinder 14. The rod 13 serves as a driving shaft which drives the valve element 11 in the direction of an arrow a in FIG. 5A to come close to the exhaust port 10 and the direction of an arrow b in FIG. 5A to separate from the exhaust port 10. The cylinder 14 drives the rod 13. The rod 13 extends parallel to the moving direction of the valve element 11, and the valve element 11 is supported at one end of the rod 13. The cylinder 14 is arranged outside the connecting member 8 and connected to the other end of the rod 13. The connecting member 8 is integrally formed with an axial support 17 which supports the rod 13 to be movable in the directions of the arrows a and b. Hence, the valve element 11 is supported to be movable between a closing position P1 for closing the exhaust port 10 and an opening position P2 for opening the exhaust port 10 by the driver 12.

The size of the outer shape of the valve element 11 is larger than the opening area of one end of the connecting member 8 which is inserted in and connected to the exhaust port 10. Thus, the valve element 11 can close the end of the connecting member 8. The size of the outer shape of the valve element 11 is smaller than the opening area of the exhaust port 10 of the vacuum chamber 5a or 5b. The end of the connecting member 8 is provided with a seal portion 16 to hermetically close the interior of the vacuum chamber 5a or 5b with the valve element 11. Thus, when the valve element 11 is moved to the closing position P1, it abuts against the end face of the end of the connecting member 8 through the seal portion 16, so it can hermetically close the interior of the vacuum chamber 5a or 5b.

As shown in FIGS. 5A and 5B, the driver 12 is provided with a bellows 18 which covers the outer surface of the rod 13 so as to hermetically seal the rod 13 and cylinder 14 in a vacuum state. One end of the bellows 18 is fixed to the axial support 17, and the other end thereof is fixed to the bearing portion of the cylinder 14. The hermetical closing mechanism to hermetically close the rod 13 and cylinder 14 in the vacuum state is not limited to an arrangement that uses a bellows member such as the bellows 18. Another arrangement that uses, in place of the bellows member, for example, an O-ring (not shown) fitted on the outer surface of the rod 13 may also be employed.

According to this embodiment, the valve element 11, rod 13, cylinder 14, connecting member 8, and exhaust pump 6 which constitute a set of exhaust system can be removed from the vacuum chamber 5a or 5b comparatively easily without dismantling them all.

Assume that with the interior of the connecting member 8 being evacuated, the valve element 11 is at the closing position P1 and the interior of the vacuum chamber 5a or 5b is to be pressurized to near the atmospheric pressure. Since the valve element 11 is arranged in the vacuum chamber 5a or 5b, it receives the atmospheric pressure acting on the exhaust port 10. Hence, in this case, the atmospheric pressure does not depend on the driving force that closes the valve element 11 by the cylinder 14. Therefore, the cylinder 14 can be made into a comparatively small size that produces only a driving force necessary to move the valve element 11 and rod 13 in the direction of the arrow b when closing the valve element 11. As a result, according to this embodiment, when compared to the conventional arrangement in which the driver requires a driving force equal to or higher than the atmospheric pressure acting on the exhaust port, the cylinder 14 of the driver 12 can be made compact.

As shown in FIG. 5A, where necessary, a variable orifice 23 may be arranged between the exhaust pump 6 and connecting member 8.

Concerning the vacuum processing apparatus 1 according to this embodiment having the above arrangement, the operation of evacuating the interior of the vacuum chamber 5a or 5b will be described.

When evacuating the interior of the vacuum chamber 5a or 5b, the exhaust pump 6 is driven. At this time, the valve element 11 may be located on either the closing position P1 or opening position P2.

First, when restoring, namely, opening the interior of only the vacuum chamber 5a or 5b to near the atmospheric pressure, the cylinder 14 is driven, so that the valve element 11 is moved in the direction of the arrow b and is stopped at the closing position P1. After that, the interior of only the vacuum chamber 5a or 5b is open to near the atmospheric pressure.

Successively, when the interior of the vacuum chamber 5a or 5b is to be evacuated to a vacuum, an auxiliary pump evacuates the interior of the vacuum chamber 5a or 5b. After that, the cylinder 14 moves the rod 13 in the direction of the arrow a so the valve element 11 is stopped at the opening position P2.

According to the vacuum processing apparatus 1 of this embodiment, the connecting member 8 extends in a direction inclined with respect to the moving direction of the valve element 11, and the rod 13 of the driver 12 extends in the moving direction of the valve element 11. With this arrangement, the space outside the vacuum chamber 5a or 5b which is necessary to install the exhaust pump 6 and the cylinder 14 of the driver 12 for the gate valve 7 can be reduced, thus reducing the space. Hence, with the vacuum processing apparatus 1, the entire apparatus can be made compact.

According to this embodiment, the valve element 11 is smaller than the exhaust port 10 of the vacuum chamber 5a or 5b, and the seal portion 16 is formed at the end of the connecting member 8. Thus, a set of exhaust system including the gate valve 7 and exhaust pump 6 can be removed and attached in an assembled state from and to the vacuum chamber 5a or 5b.

More specifically, the gate valve 7 can be removed from the vacuum chamber 5a or 5b comparatively easily without dismantling the gate valve 7 and exhaust pump 6 completely. Therefore, with the vacuum processing apparatus 1, the working efficiency in maintaining, e.g., the driver 12 of the gate valve 7 can improve.

Also, according to this embodiment, as the valve element 11 is arranged in the vacuum chamber 5a or 5b, the cylinder 14 of the driver 12 can be made compact.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-170393, filed Jun. 30, 2008, and No. 2009-095145, filed Apr. 9, 2009, which are hereby incorporated by reference herein in their entirety.

What is claimed is:

1. A stacked load lock chamber comprising:
a first load lock chamber;
a second load lock chamber stacked on the first load lock chamber;
a first slit-valve mover configured to open and close a first opening provided to an atmosphere side of the first load lock chamber;
a second slit-valve mover configured to open and close a second opening provided to an atmosphere side of the second load lock chamber;
a first arm connected to the first slit-valve mover;
a second arm connected to the second slit-valve mover; and
a driver located below the first and second load lock chambers and configured to drive the first and second arms to move the first and second slit-valve movers through the first and second arms.

2. The chamber according to claim 1, wherein the driver is configured to drive the first slit-valve mover and the second slit-valve mover in opposite directions when opening the first opening and the second opening, and drive the first slit-valve mover and the second slit-valve mover in opposite directions when closing the first opening and the second opening.

3. The chamber according to claim 1, wherein a partition member is arranged between the first slit-valve mover and the second slit-valve mover.

4. The chamber according to claim 1, wherein
the first slit-valve mover is connected to the first arm, and the first arm is provided with a first hinge which allows to rotate the first arm so that the first slit-valve mover moves to a position spaced apart from the first opening of the first load lock chamber, and
the second slit-valve mover is connected to the second arm, and the second arm is provided with a second hinge which allows to rotate the second arm so that the second slit-valve mover moves to a position spaced apart from the second opening of the second load lock chamber.

5. A substrate processing apparatus comprising:
a cylindrical transfer chamber including a polygonal bottom surface and a polygonal upper surface, and a plurality of side surfaces connected to a plurality of process chambers; and
a stacked load lock chamber according to claim 1 which is connected to adjacent ones of the plurality of side surfaces of the transfer chamber.
